(19) United States
(12) Patent Application Publication
(10) Pub. No.: US 2014/0214495 A1
(43) Pub. Date: Jul. 31, 2014

(54) BUSINESS INTELLIGENCE SYSTEMS AND METHODS

(71) Applicant: iVedix, Inc., Pittsford, NY (US)

(72) Inventors: Rajesh Kutty, Pittsford, NY (US); Jean Michel Guillemin, Pittsford, NY (US)

(73) Assignee: iVedix, Inc., Pittsford, NY (US)

(21) Appl. No.: 14/041,248

(22) Filed: Sep. 30, 2013

Related U.S. Application Data
(60) Provisional application No. 61/708,024, filed on Sep. 30, 2012.
(60) Provisional application No. 61/712,445, filed on Oct. 11, 2012.

(51) Int. Cl. G06Q 10/06

(52) U.S. Cl. CPC G06Q 10/0637
USPC 705/7.36

(57) ABSTRACT

Disclosed is a computer readable storage medium including executable instructions to provide a navigational menu and a choice of actions as a graphic user interface (GUI). The disclosed embodiments are particularly suited, but not restricted, to Business Intelligence (BI) applications requiring hierarchical menu items to be drilled down or up and searched across dimensions. Also disclosed is a computer readable storage medium including executable instructions to configure the content and the layout of a mobile application for a business intelligence dashboard, particularly displaying and interacting with data under any form of graphical or tabular visualization.

This application claims priority from the following U.S. Provisional Patent Applications: 61/708,024 for “BUSINESS INTELLIGENCE SYSTEMS AND METHODS,” by R. Kutty and J. M. Guillemin, filed Sep. 30, 2012; and 61/712,445 for “BUSINESS INTELLIGENCE SYSTEMS AND METHODS,” by R. Kutty and J. M. Guillemin, filed Oct. 11, 2012, both of which are hereby incorporated by reference in their entirety.

In one embodiment, the disclosed system includes a computer readable storage medium including executable instructions to provide a navigational menu and a choice of actions as a Graphic User Interface (GUI), referred to herein as a contextual radial menu apparatus or device. The disclosed embodiments are particularly suited, but not restricted, to Business Intelligence (BI) applications requiring hierarchical menu items to be drilled down or up and searched across dimensions.

The following disclosure relates generally to data visualization and data interaction. More particularly, this disclosure relates to performing data visualization aimed at selecting items or actions like a system of menus and sub-menus associated with software. Thanks to its circular or radial geometry of several disclosed embodiments, the apparatus does not have any physical limitation of number of menus and sub-menus. The size of the navigational interface is arbitrary but, importantly, it does not grow along with the number of displayed sub-menus. Thanks to its mobility, menu items and action buttons can change depending upon the position on a screen or page.

Also disclosed is the content and the layout of a mobile application for a Business Intelligence (BI) dashboard, particularly displaying and interacting with data under any form of graphical or tabular visualization.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND AND SUMMARY

Business Intelligence (BI) generally refers to a category of software and network-based systems and applications used to improve business enterprise decision-making and governance. These software tools provide techniques for analyzing and leveraging enterprise applications and data. These tools are commonly applied to financial, human resource, marketing, sales, service provision, and customer and supplier analyses. More specifically, these tools can include: reporting and analysis tools to analyze, forecast and present information, content delivery infrastructure systems for delivery, storage and management of reports and analytics, data warehousing systems for cleansing and consolidating information from disparate sources, and integration tools to analyze and generate workflows based on enterprise systems. Business Intelligence tools work with data management systems, such as relational databases or On Line Analytic Processing (OLAP) systems used to collect, store, and manage raw data and transactional enterprise systems that generate data. A subset of business intelligence tools are reports, OLAP systems. Enterprise Information Management (EIM) systems. Extract Transform and Load (ETL) systems, Dashboard, Analytics, and the like.

BI tools provide users with a Graphical User Interface (GUI) that enables them to interact with the application, for example, to select items or trigger actions. Interactive reports and dashboards require commonly filtering data; it can be the selection of a single attribute value but also bigger pieces such as a whole dimension or subset of data. Modern BI tools require users to navigate across hierarchies, typically to drill down data in order to get more details.

Software applications that provide interactive displays are known and widely used in business intelligence and other environments. A frequently used technique for the application is a drop down control. The control often provides clues and/or required choices for entry into a specified field.

It is common in today's computing environment to present information to a user in graphic user interfaces. A suitable user interface screen may include, for example, a display region and a number of user interface controls, which may be presented in the form of menu bars. The menu bars may be expanded (i.e., in a drop down menu) to display various selectable options. Typically, the number of interactive functionalities that a user interface allows is proportional to the number of options displayed in connection with the menu bars on the user interface screen. Thus, the higher the number of options the harder it becomes to display the options in an organized and unobtrusive fashion on the user interface screen.

In Microsoft's Windows or other operating system applications, drop down controls are activated by selecting an arrow in the right hand corner. A drop down list is then displayed for user selection. The selection is made by clicking on the appropriate choice. As soon as the choice is made, the list is hidden and the choice is displayed in the text box. The list may have scroll bars if there are too many items for display in a single view. The Macintosh operating system uses a similar technique called PopUp buttons. By pressing and holding the mouse button, a list is displayed. As long as the mouse button is depressed, the list remains visible. By scrolling the mouse pointer down the list, the user can make a selection. Once the proper choice is highlighted, the mouse button is released and the selection is made.

Regardless of which technique(s) is used, if the list of choices becomes too long, the practicality of the drop down list is reduced. In fact, at some point it may become necessary to create additional drop down controls to hold the extra choices. Thus, there is a need for a method and apparatus which allows a category of choices in a drop down control in order to save valuable screen space and user time. Conventional approaches to the above challenges have included such arrangements as providing sub-menus to a consolidated main menu, where the sub-menus may only appear when the user selects an option from the main menu. Unfortunately, when the sub-menu is expanded from the main menu, the entire nest of menus still takes up a lot of screen space. In the arrangement in which the main menu is made to disappear when the sub-menu appears, the user faces the difficulty of being unable to backtrack if the sub-menu turns out not to be what the user desires.

Other typical approaches to the above problem include restricting the number of options that the user may access in a particular user interface screen. The options that the user may access in association with a particular user interface screen may be pre-determined, for example, by a computer system based on what's been displayed on the user interface screen. Alternatively, the options may be user determined, for example, through user selections. A problem with these arrangements is that the system or the user cannot accurately anticipate which options the user may wish to access in a particular user interface screen and, therefore, may create unnecessarily restrictive menu options. These may frustrate the user.

A different and less frequently used approach to the above problem is a “bulls eye” menu in which options are presented in progressively outward-expanded concentric cycles, much like a shooting target with a central bulls eye. The options in circular layers that are closer to the center are higher level options. Associated lower level options may be displayed in additional circular layers that may be farther away radially from the center. One advantage of a bulls eye menu is faster user selection. For example, by allowing the user to directly move a mouse pointer to a desired option in one of the concentric layers. Selection speed associated with this direct movement, calculated based on Fitt's law, which predicts the time required to rapidly move from a starting position to a final target area as a function of the distance to the target and the size of the target, is much faster than selection made from a traditional menu, such as a drop down menu. A disadvantage of the bulls eye menu is its rigid format, which requires an entire circular layer to be added to the outside of the concentric circles when a single option beyond the current outer layer is to be added. This expansion may sacrifice an unnecessary large amount of screen area. The bulls eye menu's circular format also does not allow easy linear mapping of user selection steps through the layers.

Traditional menu bars and the like, as noted above, do not contrast the two fundamental types of choices in a menu: selection versus activation. The selection of a color in a menu, blue versus red, is basically different from selecting print for instance; both are presented without any dissemblance in traditional menus. Some applications resolve this issue by having a dual interface control; for instance, a traditional menu bar for pure selection beside separate buttons or icons outside menus. This makes user interfaces confusing and not consistent across applications.

Traditional menus and the like generally apply on a whole screen or window; the position, traditionally on the top, would make additional menu bars odd and cumbersome on other areas of the screen. Having one global menu becomes an inconvenience when several areas exist, each of them requiring exclusive or distinguishable selections or actions. For instance, a window on which is displayed a dashboard and another one showing a related graph would be more adequate with two different menu interfaces; the one offering a selection of dashboard visualization such as fuel gauges, thermometers and the other one enabling users to add a legend or change the scale of the graph axis for instance. This issue has been overcome by contextual menus that appear upon, for instance, right mouse click. However contextual menus work only if a mouse, or an equivalent physical apparatus, is available on the computer and they are not permanent on the screen. Moreover, they offer a limited set of choices.

The selection of an item, for which sub-items exist, is not allowed in a drop down or popup menu and the like described above. There are, however, situations where a menu item must be both, a selectable item and an entry for a submenu. A typical example in a business information application is when browsing a cube wherein a hierarchy (i.e. time), as a menu item can be selectable (for instance to be included in a report), but may also be an entry for displaying the list of its levels (years, quarters, etc.). In a drop down or popup menu each item is exclusively either a sub-menu entry or a selection but cannot be both.

Multi-selection is not addressed in the drop down or popup lists. Large menu interfaces having many sub-menu levels are not easy to remember or to be navigated across. Users get easily lost among too many selection items. Popup and drop down menus and the like above do not offer a search feature that would allow users to be directed to a given sub-menu item.

New computers such as tablets and phones (e.g., smartphones) require more modern interface controls, especially for menus. The absence of a mouse in such devices requires using directional and touch gestures. This is a major interface control switch that calls for better suited menu and navigational mediums to leverage those gestures.

In view of the above, a need exists for an improved way of presenting contextual menu options on a user interface screen to provide easy access to desirable options, to minimize occupation of display space as well as to leverage new computer device gestures and touch-screen interfaces. The solution should address the ambiguities related to the nature of menu item: selection versus action. In the context of business intelligence applications, it would be helpful to provide a solution that allows users to navigate across a series of dimensions, hierarchies and measures. The navigation would be facilitated by an integrated search function inside the interface control. Moreover, the mobility or movement of a menu apparatus, allowing it to be located at any position over an entire screen, would provide a natural way to change menu options.

In one embodiment, the disclosed systems and methods provide a navigational device or menu apparatus shaped like a disc having a two-layer structure: a wheel or other rotatable shape and a partial shield on top, both assembled on a common axle/axis; the rotating wheel, made of retractable inner rings, holds the selectable menu and sub-menu items while the shield is the support for the action buttons. Moreover, although described in terms of components in a physical apparatus, the disclosed navigational device is preferably, in at least one embodiment, implemented as a virtual display technique depicted on a display or user interface.

Unlike a popup menu the disclosed embodiments may include a 3D apparatus on which additional information can be displayed. The bread crump side of the wheel can be used for displaying information such as the selected path or the search result among other pieces of information. For instance, search can be processed from the apparatus and the result displayed on it.

Unlike the traditional windows menu, the disclosed navigational system is designed to leverage the gestures integrated with the operating system (OS) of portable computing devices such as tablets and similar touch-screen devices. Different gestures will drive different actions. For instance, touching a dimension will drill down at the first level of the dimension displaying the attributes and possibly the hierarchy on the wheel while dragging the dimension and dropping it on a graph will add a new dimension to a graph.

Unlike the traditional Windows® menu the apparatus is movable over the screen and the menu items and actions vary upon the position. The apparatus is also removable from the screen. The disclosed embodiment includes a computer readable storage medium with executable instructions to select information or action to perform within an application context. An example of such instructions is the search of items across dimension given a set of selection criteria.

Also disclosed in embodiments herein is a computer readable storage medium including executable instructions to configure the content and the layout of a mobile app. The disclosed embodiments are particularly suited, but not restricted, to Business Intelligence (BI) dashboard applications requiring displaying, and interacting with, data under any forms of graphical or tabular visualization

Further disclosed in embodiments herein is a computer-executed method including executable instructions to communicate information across various recipients, where passing data or parameters from one window to another is required, in a common embodiment of a recipient (defined as a screen area) where some content is displayed or an application is running therein.

Also disclosed herein is a uniform syntax including executable instructions to parse the syntax and convert it into specific query language for accessing data directly from a database or from any other sources accessible from a resource locator (e.g., URL) string. This aspect is particularly suited to computer software requiring accessing disparate data stored in heterogeneous source systems.

Further disclosed herein is a computer controlled method, including executable instructions, to determine adequate visualization of a set of data. This functionality requires a formalization of “data visualization”; a specific topology, referred to herein as “Data Visualization Topology” (DVT), and is, therefore, a fundamental aspect of the disclosed embodiments.

Additionally disclosed herein is a method, executed in response to programmatic instructions, to bundle data available from Internet with traditional data from a database(s). This feature is particularly suited, but not restricted, to computer software aiming at collecting and analyzing data from social media sites, sometimes unstructured, in conjunction with traditional structured data stored in a database(s).

Further disclosed herein is a framework enabling companies to deploy customizable Business Intelligence apps on mobile devices (e.g., tablets). The framework is uniquely configurable to specific data sources and visualization elements. The application (app) layer also provides for end user layout and content customization.

### BRIEF DESCRIPTION OF THE DRAWINGS

FIG. 1 illustrates a computer constructed in accordance with a disclosed embodiment;

FIG. 2 illustrates the navigation inside the hierarchy of menu in accordance with a disclosed embodiment;

FIG. 3 illustrates the item selection processing in accordance with a disclosed embodiment;

FIG. 4 illustrates the activation of contextual action processing in accordance with a disclosed embodiment;

FIG. 5 illustrates the search of item processing in accordance with a disclosed embodiment;

FIG. 6 illustrates an example of hierarchy representing menu nodes associated with a disclosed embodiment;

FIG. 7 illustrates the display of a menu and sub-menus on the wheel with a disclosed embodiment;

FIGS. 8A-8G illustrate the rotation of the wheel under the shield to display more menu items in accordance with a disclosed embodiment FIGS. 9A-9B illustrates the search result in accordance with a disclosed embodiment;

FIG. 10 illustrates the spatial representation in 3D of the navigational aid used to display search criteria in accordance with a disclosed embodiment;

FIG. 11 is a general illustration of configurator functionality, including a configuration database;

FIG. 12 is an illustrative example of an App Resource, as characterized by its underlying database entries;

FIG. 13 is a sequential series of steps representing a process for uploading the configuration of an App Resource;

FIG. 14 is a block diagram illustrating the interrelationship amongst various component of the disclosed system and methods;

FIG. 15 is an illustrative example of objects that may be dragged and dropped in accordance with an aspect of the disclosed embodiments;

FIG. 16 is an exemplary schema representing the context of the neutral query specification;

FIGS. 17, 18A, 18B, 19A and 19B are illustrative examples of alternative visualization topologies;

FIG. 20 is an example of a data context mixing Internet data with structured database data;

FIG. 21 is a schematic illustration of one embodiment for the linkage of social media information;

FIGS. 22A-22B are illustrative examples of a what-if visualization method in accordance with the disclosed system.

The various embodiments described herein are not intended to limit the disclosure to those embodiments described. On the contrary, the intent is to cover all alternatives, modifications, and equivalents as may be included within the spirit and scope of the various embodiments and equivalents set forth. For a general understanding, reference is made to the drawings. In the drawings, like references have been used throughout to designate identical or similar elements. It is also noted that the drawings may not have been drawn to scale and that certain regions may have been purposely drawn disproportionately so that the features and aspects could be properly depicted.

### DETAILED DESCRIPTION

The following terminology is used in describing embodiments of the systems and methods:

A hierarchical menu is a structure of a set of levels of nodes. A hierarchical menu can be depicted of a directed tree that displays data in a hierarchical format. A flat menu is a singular occurrence of a hierarchical menu; it is a hierarchical menu with no sub-menu. The general term hierarchical menu is used.

A sub-menu is a set of nodes of the level immediately below a given menu item.

A node is a visual depiction of an item of a hierarchical menu. A node is depicted in a specific level of a hierarchical menu. A node is depicted in relation to other nodes within a hierarchical menu. A node is associated with a named menu item identifiable by the users.

A selection is a choice among a list of specific type of menu items that affects the data population inside a grid, chart or the like. A selection serves as command in order to either extending or filtering a set of data to display. A selection must have a destination such as a chart, a grid or the like wherein the selection is applied to change the data.

An action is a choice among a list of specific type of menu items that kicks off a process. Unlike selection, action does not require a destination; it just activates a process whose execution does not affect the selection of data in a grid, chart or the like.

A dimension is a type of data model object that represents a side such as a category, a column or a set of data items within a data source. Each dimension represents a different category, such as region, time, or product type. Dimension definitions support the specification of hierarchies to form a hierarchical dimension where dimension levels are constrained by hierarchical logic. Members of a dimension may be defined through a filter or transform.

A dimension can contain one or several hierarchies corresponding to a level of nodes in a hierarchical menu. The members of a dimension hierarchy, represented by nodes, are used to determine how to break down the data provided by the preceding level. For instance a food item dimension could contain a pyramid-based food categories and sub-categories such as fruit, meat, dairy on one level and then, on a lower level, apple, orange, plums under fruit, beef, chicken under meat and so on.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources may include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as Open DataBase Connectivify (ODBC) and the like. Data sources may also include a data source where the data is not stored like data streams, broadcast data, and the like.

A data filter is selection criteria used for retrieving relevant data from a data source, or a subset of previously received data.

A visualization is a graphic display of quantitative information. Types of visualizations include charts, grids, maps, and word-cloud, among others.

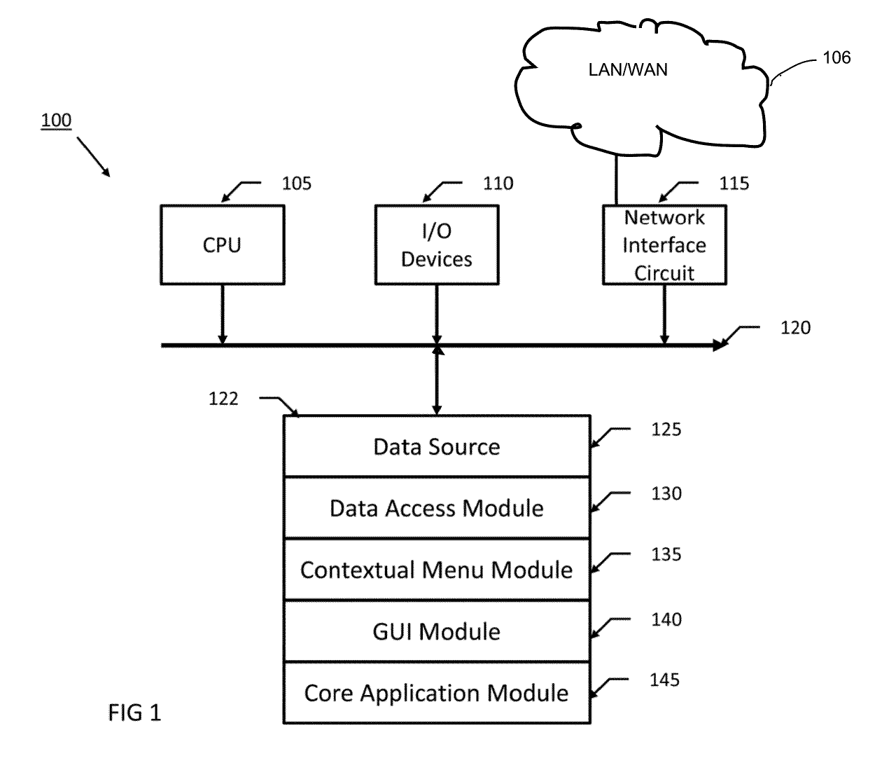

Referring now to FIG. 1 illustrated therein is a computer 100 configured in accordance with a disclosed embodiment. The computer 100 includes standard components, including a central processing unit 105 and input/output devices 110, which are linked by a bus 120. The input/output devices 110 may include a keyboard, mouse, touch screen, monitor, printer, and the like. As will be appreciated, one or more aspects of the computer 100 may be implemented using a personal and/or portable computing device such as a tablet, laptop, smartphone, etc. A network interface circuit 115 is also connected to the bus 120. The network interface circuit (NIC) 115 provides connectivity to a network 106 (local-area-network (LAN), wide-area-network (WAN), etc.) via wired or wireless technologies, thereby allowing the computer 100 to operate in a networked environment.

A memory 122 is also connected to the bus 120. In one embodiment, the memory 122 stores, among other data, one or more of the following modules: a data source 125, a data access module 130, a contextual menu module 135 and a graphical user interface (GUI) module 140.

The data source 125 stores and supplies data for the data access module 130. In one embodiment, the data source resides on a separate machine. The data access module 130 extracts data from the data source when required, constructs data filters, accesses the data source, and filters and groups the data as requested, in particular menu data. The contextual menu module 135 constructs the menu hierarchy and accepts user selection(s) or action(s) from the graphical user interface module 140. The graphical user interface module 140 displays the menu hierarchy created by the contextual menu module 135 and accepts user selection. The graphical user interface module 140 may rely upon the navigational aid in the nature of the contextual radial menu apparatus functions to an optimized user interface for menu and sub-menu selection. Graphical user interface module 140 passes the user selection made in contextual menu module to the core application module 145.

The executable modules stored in memory 122 are exemplary, and other or alternative modules may be similarly stored therein. Additional modules such as an operating system module may also be included. It should be appreciated that the functions of the modules may be combined. In addition, the functions of the modules need not be performed on a single machine. Instead, the functions may be distributed across a network, if desired. Indeed, the disclosed embodiments may be commonly implemented in a mobile device(s) with various components being implemented at the front-end side and/or the server-side. It is the functions of the disclosed embodiments that are significant, not where they are performed or the specific manner in which they are performed.

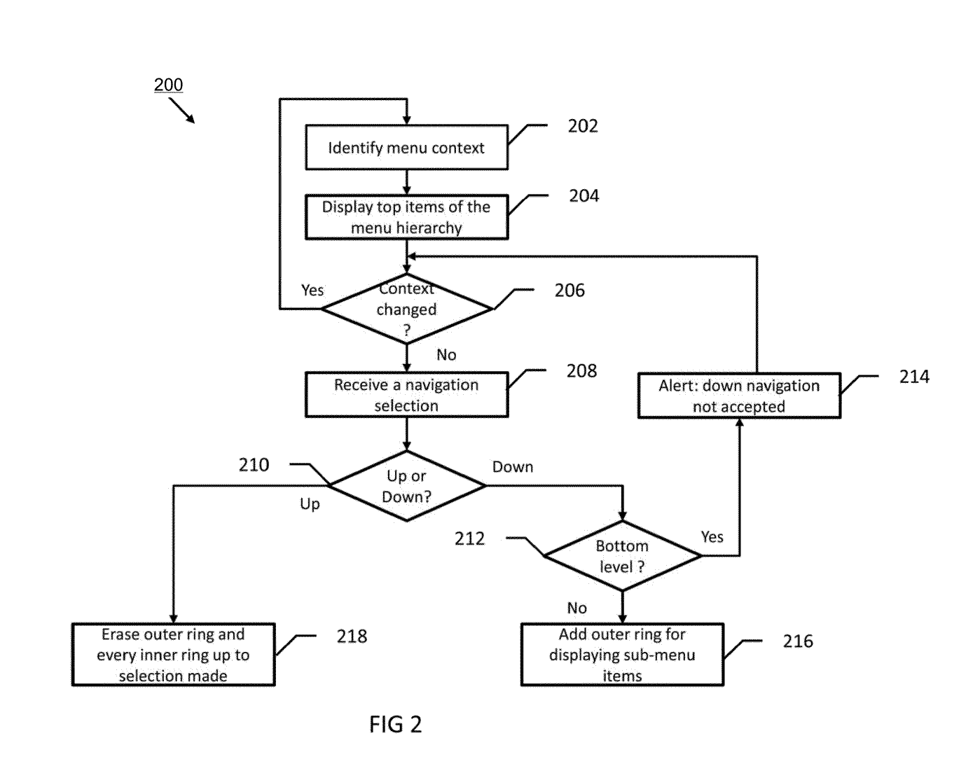

FIG. 2 illustrates a high level workflow 200 associated with a disclosed embodiment. This workflow relates to the navigation in the menu and subsequent menus. Initially, the contextual menu module 135 identifies the context of a menu, operation 202, which is transmitted to the graphical user interface module 140 for displaying the top level menu items 204 to the user. The context can change based on the user's interaction with the computer 100. Therefore, the contextual menu module 135 identifies, in real-time, the context of a menu 202; if the context is changed, test 206, then the graphical user interface module 140 refreshes the menu items 204 accordingly. In a given context the graphical user interface receives a navigation selection 208. The user can request two possible types of navigation 210 in a menu: navigate up, which goes back to the upper level of the menu, and navigate down, to display a sub-menu. It is not possible to navigate lower than the bottom level in a menu, test 212; if the user attempts to do so then an alert is triggered at operation 214. If a subsequent menu is available then an outer ring is displayed with the sub-menu items 216. Navigating up into a menu erases the outer ring as represented by operation 218.

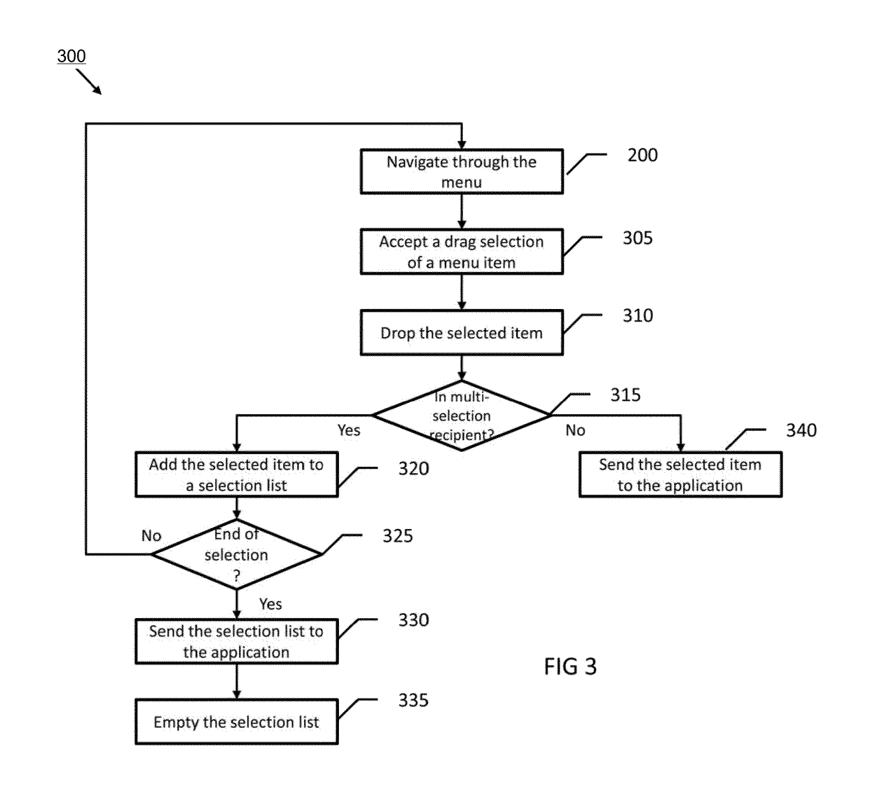

FIG. 3 illustrates a high level workflow 300 associated with a disclosed embodiment. This workflow relates to selecting menu items. The user navigates across the menus and sub-menus 200 in order to get a list of selectable items displayed along the outer ring, as represented in the operations 216, 218 of FIG. 2. An item is accepted as a selection, operation 305, and is dropped, operation 310, either directly into the application as represented at 340 or a multi-selection recipient based upon test 315. If the selection is dropped into the multi-selection recipient then the selected item is added to the current selection list, operation 330. This entire process from the navigation 200 to the multi-selection 320 can be repeated until the user decides to release the multi-selection 325. The selection list is then passed to the application 145 (FIG. 1) through the graphical user interface module 140. The selection list is then emptied 335. The single selection case, reflected via test 315, passes the individual selected item to operation 340 to the core application module 145 through the graphical user interface module 140.

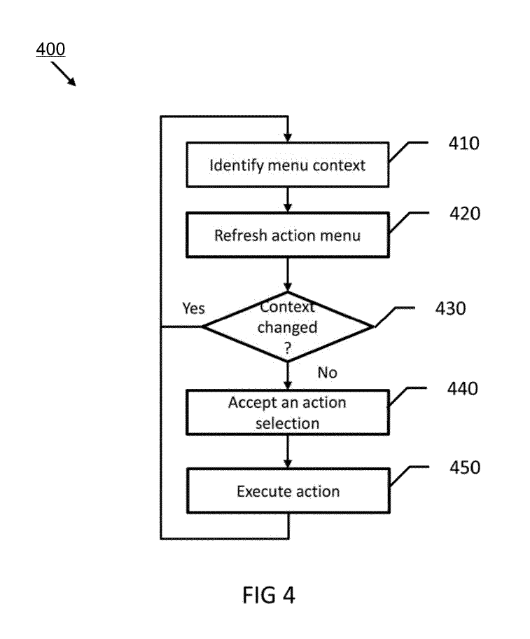

FIG. 4 illustrates a high level workflow 400 associated with a disclosed embodiment. This workflow relates to selecting action items. Initially, the contextual menu module 135 identifies the context of a menu, operation 410, which is passed to the graphical user interface module 140 for displaying the action item menu to the user. The context can change, as reflected in test 430, based on the user interaction with the computer 100. Therefore, the contextual menu module 135 identifies real-time the context of a menu 202; if the context is changed, for example in operation 206 (FIG. 2), then the graphical user interface module 140 refreshes accordingly the selectable action items as represented by operation 420. In a given context the graphical user interface module 140 receives an action selection, operation 440. The action is then passed to the core application module 145 for execution as represented by operation 450.

FIG. 5 illustrates a high level workflow 500 associated with the disclosed embodiment. This workflow relates to searching menu items. After a request for search is initiated, operation 505, then the user is allowed to input multiple search criteria as represented in operation 510. The search engine associated with the disclosed embodiment can be launched as shown by operation 515. If there is at least one matching item found, determined by test 520, then the search result is displayed at operation 530, where a slice in the wheel is allocated for each found item. Then the user can make a selection of a found item, operation 535, that will refresh the menu list, operation 540, and thereby highlighting the found item on the outer ring; the navigation lineage is also displayed, each level represented within inner rings, as if the navigation was made manually. At that point the user can decide to navigate in the menu 305 as described in FIG. 3, or come back to the search result, reset operation 545, to make an additional selection as represented by operation 535.

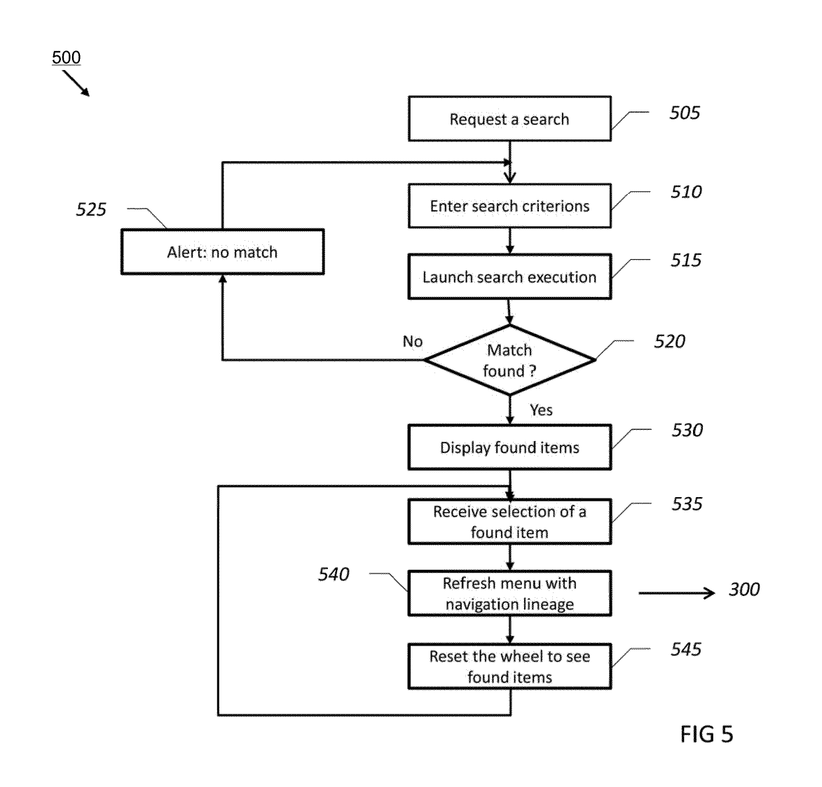

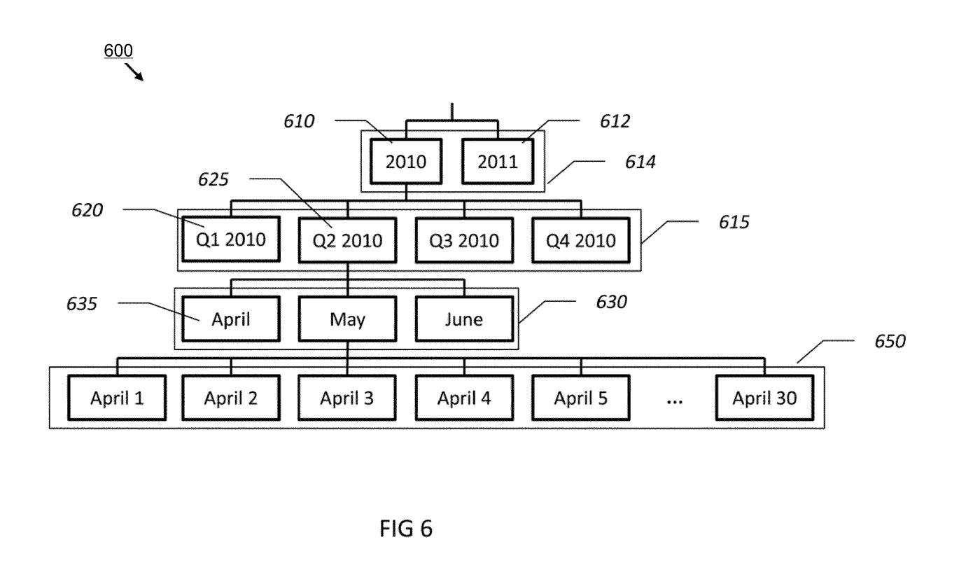

FIG. 6 illustrates an example of a hierarchical menu 600. In this illustration, the year “2010” (610) and year “2011” (612) represent the top menu items of the hierarchy; it is by convention designated as the level 1 of the menu hierarchy 614. The year “2010” is broken down into four quarters “Q1 2010” (620), “Q2 2010” (625), “Q3 2010” and “Q4 2010”. Those four subordinate nodes constitute the level 2 (615) in the hierarchy. The quarter “Q2 2010” (625) can also be broken down into the three months: “April” (635), “May” and “June”, which are part of the level 3 (630) of the hierarchy. Note the drawing illustrates only the decomposition of the quarter “Q2 2010” but it should be appreciated that the three other quarters can be broken down the same way. The drawing illustrates the decomposition of the month “April” (635) into the thirty days of this month, from “April 1st” to “April 30th”; those nodes are part of the level 4 (650) in the hierarchy.

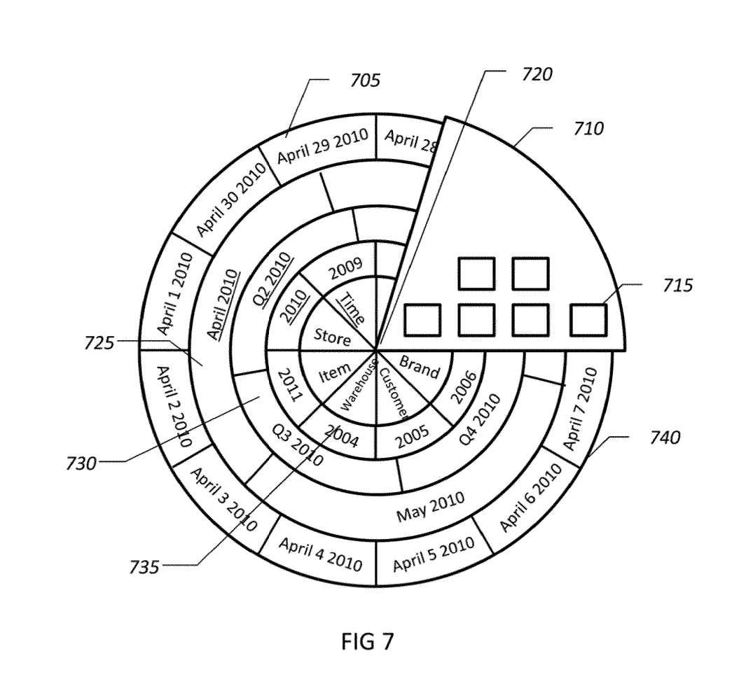

FIG. 7 is a representation of the hierarchical menu illustrated in FIG. 6 associated with invention contextual radial menu device or apparatus as may be depicted on a graphical user interface in accordance with a disclosed embodiment. The drawing shows the four levels of the time hierarchy: year 735, quarter 730, month 725 and day 705 displayed in successive rings in the embodiment. Each level is represented in a specific circular layer or ring that is progressively farther away radially from the outer ring hosting the nodes of the lowest selected level of the hierarchy. The addition and the removal of circular layers are processed according to the workflow 200 illustrated in FIG. 2. Each circular layer is divided into a number of slices or sections, where each of the slices or sections represents a node of the hierarchical menu.

The shield 710 that is shown as overlaid on top of the wheel in the FIG. 7 serves as a “fixed support” to host the action menu items. Each action item is represented with a square 715 on the shield. The list of action items to be made available on the shield varies depending on the menu context being displayed at the time. The selection of an action item is processed in compliance with the workflow 400 illustrated in and previously described relative to FIG. 4.

The wheel 740 and the shield 710 are tied together or associated using a common axle or axis at the center point 720. The wheel can rotate on the axle relative to the shield and vice-versa. The shield 710 hides a portion of the wheel 740 and thereby some slices or sections representing the nodes of the hierarchical menu may not be visible on the wheel. The number of slices visible on each circular layer is physically restricted due to the limited size of the wheel in the display. The thirty slices matching the thirty days in April cannot all be displayed on the outer ring of the wheel 740.

The shield, nonetheless, makes it possible to make visible as many slices as desired, and at least theoretically an infinite number of slices may be “hidden” behind the shield, because the wheel is rotating on its axle at point 720. The wheel and various rings therein are “rotated clockwise and anti-clockwise (counterclockwise) under the fixed shield; thus, there is a way to make apparent as many menu items as required by rotating the wheel, even though at any particular time, less than the total number of menu items (sections) are visible on the display of the menu. It is also possible to use varying numbers of levels within the disc display to enable the easy selection and navigation through a large quantity of selections, information, etc. A similar functionality holds true for the shield as well. Various selectable action items 715 are depicted on the shield 720. However, once the shield is “filled” with action items 715, the action items, like the slices on the wheel or disc, are rotated through the shield display region thereby allowing for the view of multiple action items, and in particular more than can be easily depicted within the display region of the shield. It will also be appreciated that the display characteristics of the action items (e.g., size of a thumbnail image or icon representing the action) may be customizable so that the number of items that may be displayed in the region of the shield is also dependent upon the action item thumbnail size.

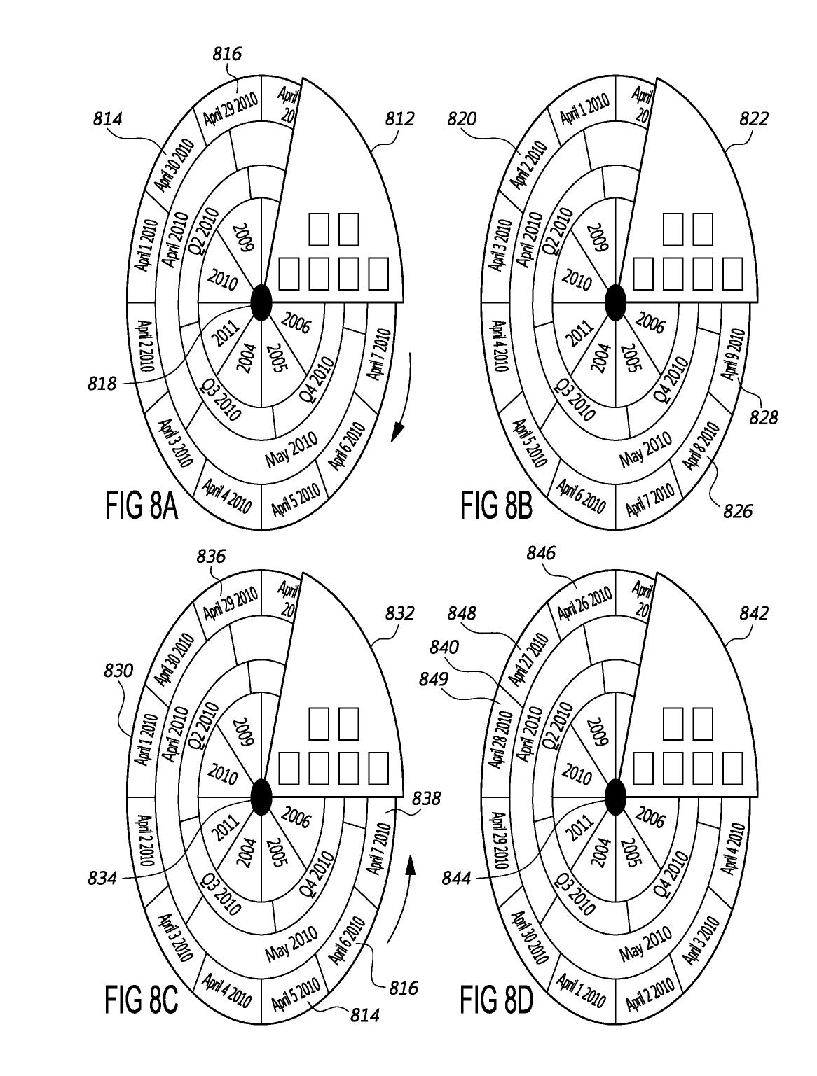

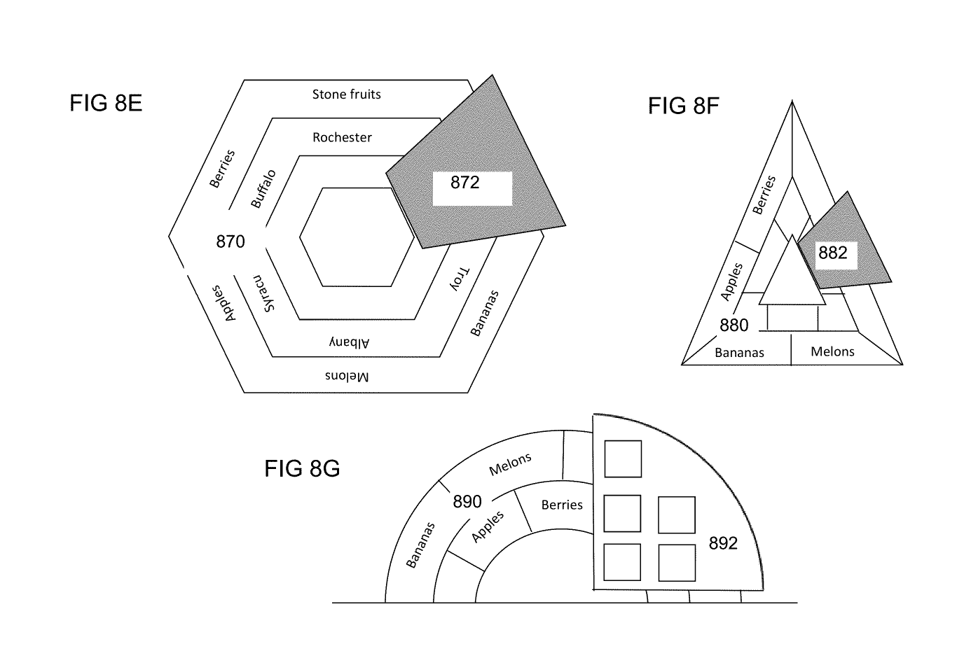

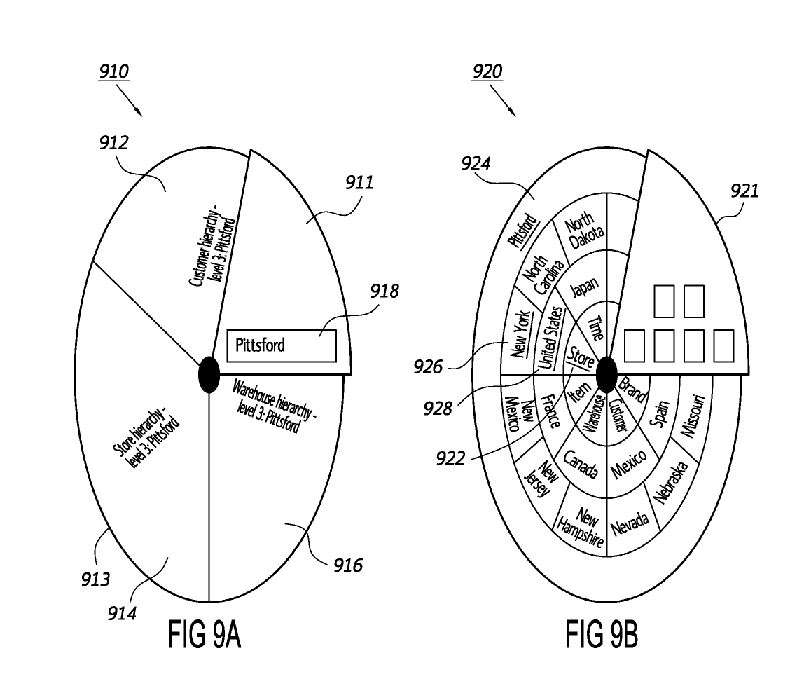

Referring first to FIGS. 8A-8D, there are exemplary illustrations of the use of the contextual radial menu described above. In FIG. 8A, an initial position of the wheel or disc is represented, and in FIG. 8B, the position of the wheel after a roughly 45-degree rotation clockwise is illustrated by the rotation of the outer ring of the wheel 820 in order to display two additional slices: “Apr. 8, 2010” (826) and “Apr. 9, 2010” (828). As a result of the rotation the two slices “Apr. 30, 2010” (814) and “Apr. 29, 2010” (816) from the FIG. 8A are now hidden under the shield 822 in FIG. 8B. Note that the shield 822 can hide as many slices as necessary. In the embodiment depicted actually twenty-one slices from “Apr. 10, 2010” to “Apr. 30, 2010” are hidden in FIG. 8B.

Turning to FIG. 8C, which again represents an initial position of the wheel, and FIG. 8D, which represents the position of the wheel after a roughly 90-degree rotation anti-clockwise; the rotation of the outer ring of the wheel 830 is seen to have changed in order to display three additional slices or sections: “Apr. 26, 2010” (846), “Apr. 27, 2010” (848) and “Apr. 28, 2010” (849). As a result of the rotation the three slices “Apr. 5, 2010” (814) and “Apr. 6, 2010” (816) and “Apr. 7, 2010” (838) from the FIG. 8C are now hidden under the shield 842 in the FIG. 8D

Alternative embodiments of the contextual radial menu (CRM), or more generally referred to in several instances herein as the “DISC,” will now be described. While the contextual radial menu is depicted in the shape and format of a disc, it is important to note that it is not required to be in this form for the principles behind its design and operation to be fulfilled and its advantages realized. There are several aspects of the contextual radial menu that are sufficiently represented by the disc, but not exclusively so. Rather, the contextual radial menu should be envisioned in a variety of shapes, figures, or forms. FIGS. 8E-8G show different embodiments and shapes of the contextual radial menu, although all include several common characteristics.

For example, the menu is contextual. That is, the information that is displayed on the portions of the menu that are navigable is generated based on several contexts, which may include: data context, user choices, user permissions, software configuration, hardware configuration, and the method of interaction with the apparatus. In addition, the context applies to the real-time changes that occur in the display. For example, the selection of one menu item will bring up a submenu selection of different choices. These choices will be contextually dependent upon what the user has selected beforehand.

The contextual radial menu is radial or rotatable. That is, the menu operates by providing information that is present on the shape's outer perimeter or radius, or information that rotates or is situated around a central point or region. In some embodiments, the information may be maintained in a generally equidistant relationship based upon the level (e.g., ring) in which the navigation or menu information is displayed. All subsequent selections on the contextual radial menu will either expand or collapse along a radial line, thereby providing a menu display process that maintains the shape of the contextual radial menu so that it occupies the same amount of screen space.

The contextual radial display is a menu, in that it functions as a graphical representation of data points that are selectable, and it allows the user to navigate through and/or to various choices that the software interface offers. Further, submenus are stored under larger menus, with measures and dimensions accessible dependent upon context and location.

As another example, the contextual radial menu utilizes a shield or similar overlay, which is separate from the radial member, that allows for changing settings, making selections, or offering additional navigation choices.

All of the above listed characteristics of the contextual radial menu depicted relative to the disc embodiment in FIGS. 8A-8D may also be applied to various shapes (e.g., hexagon, triangle) as represented in FIGS. 8E and 8F, respectively. As represented in FIG. 8G, it is also possible to utilize partial-shapes such as arcs to provide the same abilities as the circular disc. Thus, even though the contextual radial menu may be in the shape of a disc, there is no intent to limit the shape, and the design principles above may apply to other shapes, provided those principles are implemented and an underlying system architecture (data models, etc.) are similar.

As mentioned above FIGS. 8E-8G include examples of alternative designs for the rotating “disc” or member relative to a shield. In FIG. 8E, the contextual radial menu apparatus includes a polygon-shaped member 870 that rotates or moves beneath shield 872. In FIG. 8F, the contextual radial menu is in the form of a triangular member 880 that rotates beneath a shield 882.

Having described the features and alternative embodiments of the contextual radial menu, attention is now turned to the functionality of the contextual radial menu and related techniques for access and display or business intelligence information. For example, FIG. 9A illustrates the result of a search associated with a disclosed embodiment. The drawing exemplifies the result of a search made on the keyword: “Pittsford” entered in specific edit area 918 according to the workflow 500 in the FIG. 5. Three items have been matched, each represented with a specific slice in the wheel 913: the slice 912 depicts the level 2 in the hierarchy part of the dimension: “customer”, the slice 914 is the level 3 in the hierarchy part of the dimension: “store”, the slice 916 depicts the level 3 in the hierarchy part of the dimension: “warehouse”. Those three items have been matched because the search term is associated with the three dimensions: “customer”, “store” and “warehouse” among others, each of them made of a hierarchy having a level “city” for which occurrences, respectively of customer, store and warehouse exist and are located in “Pittsford”.

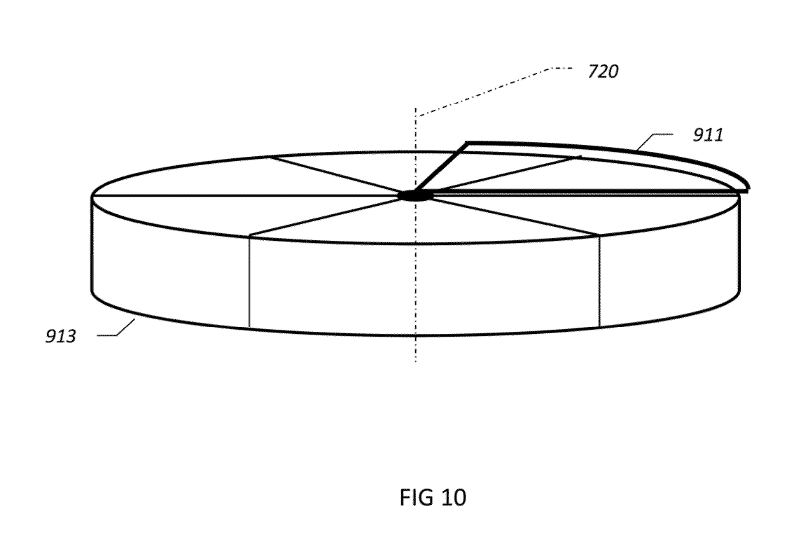

FIG. 9B is a representation of the navigation lineage of the item 914 found in FIG. 9A associated with a disclosed embodiment. The drawing depicts the visual of the contextual radial menu after the user has selected the item 914, at operation 535 in the workflow illustrated in FIG. 5. The visual is the result of a refresh of the wheel, step 540. The slice “store” (922) in the closest inner ring to the center indicates that the selected item found “Pittsford” is under the dimension “store”. The top level items of the hierarchy are displayed in the second inner ring from the center: the slice “United States” (928) indicates that the selected found item is part of the US. The slice “New York” (926) is part of the level 2: “state” of the store hierarchy; it is underlined because “Pittsford” is in the New-York state. The outer ring is composed of one single slice: the item found and selected from in the search result depicted in FIG. 9A. FIG. 10 illustrates the spatial representation, in 3D, of the wheel of FIG. 9A, used to display search criteria. Although not included, it will be appreciated that the information represented in the perspective view of 913 may be depicted as well in a three-dimensional embodiment of the contextual radial menu.

Having described a navigational system and method attention is now turned to additional features and aspects of the system and related methodologies.

Configurator

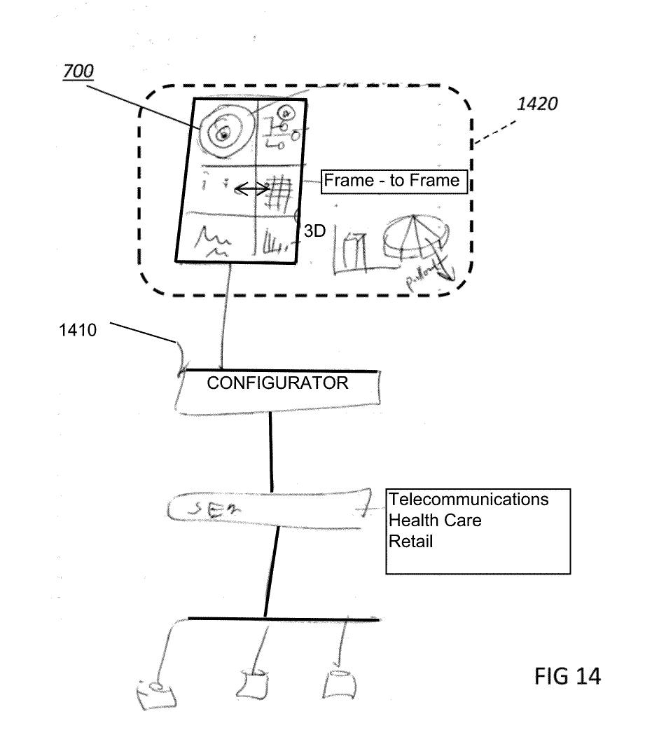

In one embodiment, the configurator (e.g., 1410 in FIG. 14), including an application configurator database (see FIG. 11), allows a mobile application to query a database and return or retrieve information in a “uniform” manner that is suitable for use across a plurality of platforms and applications. Accordingly, the configurator is “generic” in the sense that it can work with an assortment of databases, provided that it is set up to do so. This allows a single mobile app to treat all the data it displays as part of the same semantic, thereby permitting a seamless and fluid collusion of information to be presented to a user by the interface. As noted above, such features are particularly suited for the access, display and analysis of business intelligence.

The configurator may be a useful tool for configuring an interface that demands interaction between a database and an application that has multiple configurations. For example, a mobile business intelligence platform like miVEDiX benefits from the configurator for several reasons:
allows each user to customize their experience;
allows administrators to set controls on what information will be made available to each user;
eliminates the need for developing specific web services and data object maps;
allows one app to interface with various database technology platforms with minimal conversion in the middle of the process;
accelerates the deployment of business applications that use these platforms, especially in large organizations; and
once configured, the configurator needs minimal attention.

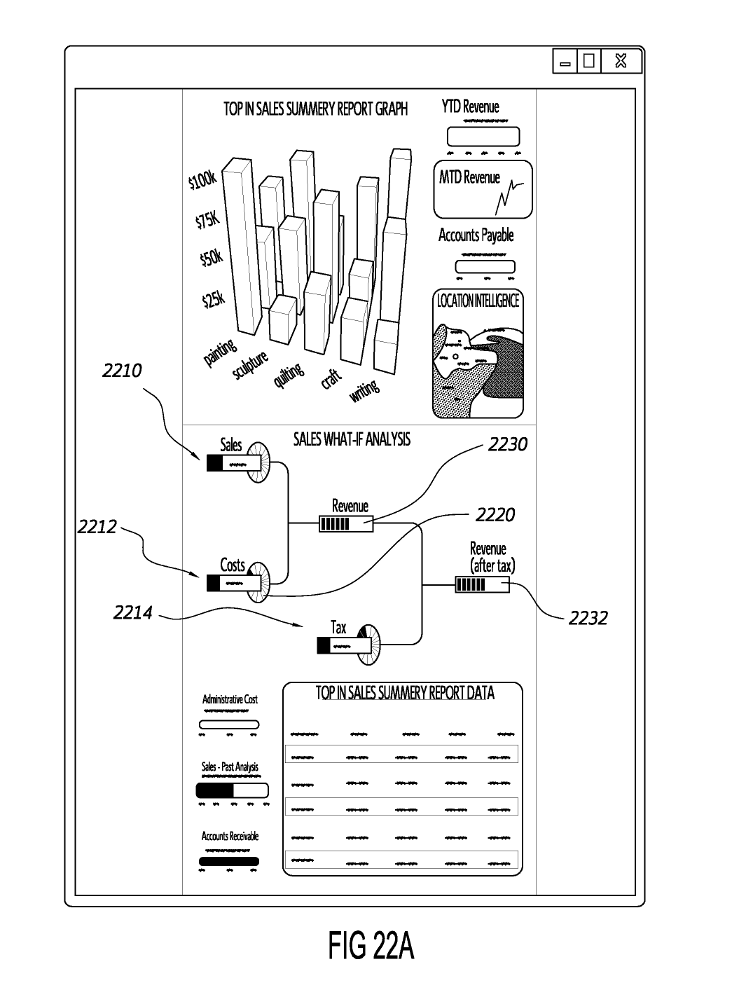

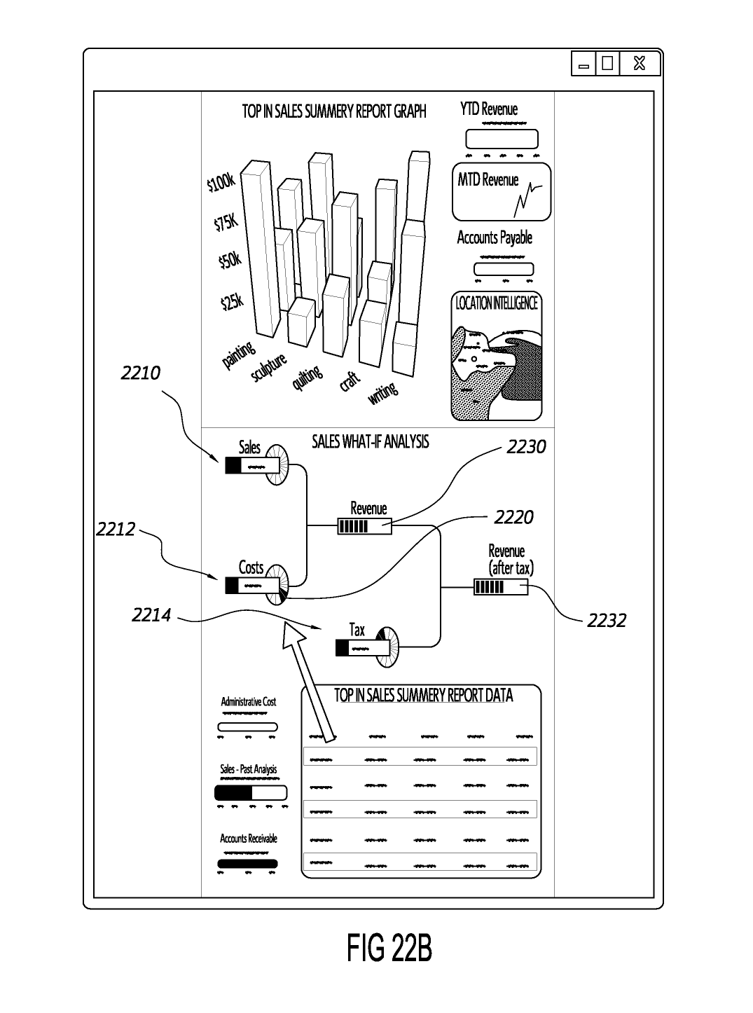

The usage of applications (apps), for example on devices 1120 in FIG. 11, to query a particular type of databases does not pose any new technical challenge per se. However, the collections of data procured by these queries, and their eventual presentation in a dashboard or other visualization (e.g., FIG. 22A), does present obstacles when the app must query a multitude and/or a variety of databases in order to present such information. The traditional way of looking at an app is to view it as the same program across multiple devices. Hence, an app for checking the weather on a mobile phone looks the same on all phones, though the data may be different depending on where the user is located).

Another, more innovative, way to is to have a similar “back end” program developed that all users share, but the appearance and the function of the app, as well as the source of the data being use, will be different depending on how it is configured. This configuration can come from an external source, and be linked to the type of information being interacted with, or in the case of databases, the different types of storage media, formats and their associated queries.

The configurator aspect of the disclosed embodiments is related to the architecture of a platform hosting the configuration of specific instances of a generic application (app). An app is traditionally an instance of a specific program; every device runs a given version of the same code and each user sees the same screens, possibly with different data, but always with the same features. A different paradigm, employed by the disclosed embodiments, is to develop a generic program for a device, parameterized with configuration arguments; every device runs the same program but each user may see a dissimilar “app” running with distinctive content and features.

In one implementation the configurator has four discrete parts: a database configuration layer; a data object mapping layer; an application frame layer; and a credentials layer. The database configuration layer acts as a gatekeeper. Once the proper credentials (permissions, users, access levels, etc.) are provided, this layer makes the appropriate determinations regarding the correct way to connect the app with the client database. The data object mapping layer serves as a central hub for mapping dimensions and measures across different databases. After it has been set up to properly interface with the databases in question (e.g., Oracle, SAP, etc.) the data object mapping layer exists as a “signpost” to both point queries in the right direction, and ensure the data is returned in a uniform format that the application can use. The application frame layer is used to store configurations for multiple applications. Each app is identified within the configurator with a unique appID as depicted in FIG. 11. Once the appropriate services are engaged, the user runs the generic app, which is identified by the configurator's usage of the appID. The user can change the appID from the device, using the settings available through the application.

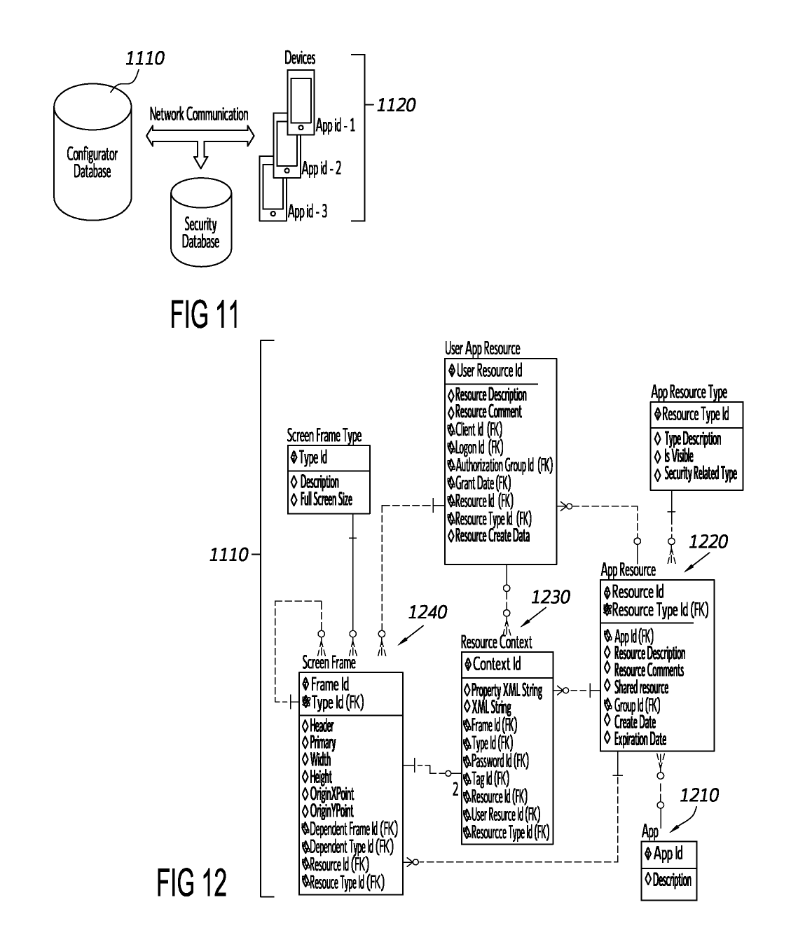

The configurator may include several discrete parts including an App Resource (e.g., FIG. 12): the constituent parts that make up the app itself. A Resource Context may also be included and comprises two parts, a data context and a property context. The data context is the determination of what is actually displayed, whereas the property context determines the physical layout and overall visualization of the content on the screen. Referring to FIG. 11, a generic app must be initiated with a given set of configuration parameters. Those are stored externally in a central database named: App Configurator. The data model of the Configurator database 1110 includes the necessary objects that enable the generic app to run a specific occurrence of it. The fundamental objects constituting the Configurator are, as represented in FIG. 12: App (1210), App Resource (1220), Resource Context (1230) and Screen Frame (1240).

The purpose of the configurator is to store the configuration of many apps; each app is identified with a unique appID. Once installed on a device the generic app must be run in association with a given appID. The user can possibly change the appID from the device using the app settings.

As noted above, an App is made of App Resources in the Configurator. An App Resource, as represented for example in FIG. 12, is a constituent of the app that may be displayable and from where the user can interact with the device. Examples of App Resources can be any sort of constituents such as dashboards, reports, key performance indicators (KPI) or another app. The configurator is not restricted to a pre-defined set of constituent types but is designed to be extensible.

The configurator also includes an App Resource (as represented in FIG. 12; 1220) made of one or several screen frames. A screen frame, or simply frame, is a rectangular recipient (or similarly-shaped region) of a given size and a given position on the device screen. A frame is like a window in which content such as text, chart or other graphics can be visualized. The user can generally interact with a frame using gestures inherent to the device. More specifically these are recipients of a given size and position on the device's screen. Generally, the frames can be interacted with, so long as the device can support such interaction as touch screen functionality, swiping, drag/dropping, and other common user interface gestures.

The content to be displayed in a frame is specified thanks to a resource context. A resource context bundles together a data and a property context. The former drives the content, the latter controls the layout of the content. A type such as grid, graph, and map among others is associated to each frame; the type of frame drives the visualization of the content in that frame.

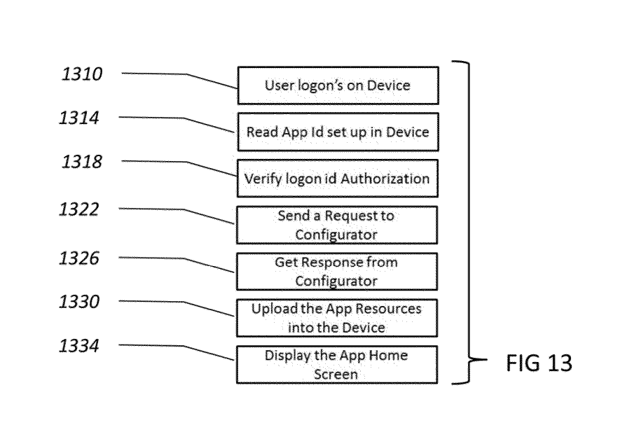

Referring to FIG. 13, the steps of the process for uploading the configuration of a given AppID into a device are illustrated. The process may include initial steps of logon (1310), reading and setting up the appID (1314), and authorization (1318). As noted at step 1322, the configurator receives a request, processes the request based upon the database information, and returns a response (1326). Subsequently, in steps 1330-1334, the app resources are uploaded into the device and the home screen for the requested app is displayed.

Briefly referring to FIG. 14, depicted therein is an exemplary representation of one embodiment representing the inter-related nature of the components described herein. For example, the disc 700 may be one of a plurality of selectable apps or features in a frame generally illustrated in region 1420. As will be described in further detail below, information may be moved from the disc to a frame, and from or between frames or regions in a frame. As one example, the following discussion is directed to a drag and drop feature in accordance with another aspect of the disclosed business intelligence systems and methods.

Drag & Drop Interaction (Disc-to-Frame, Frame-to Frame)

As the demands on data applications continue to grow, and as new technology is made available to users, the way in which decision makers approach data is changing rapidly. An expectation is that data should be instantly available to those who rely on it, and that the data must be presented or visualized in such a way as to make it understandable across a broad audience. This usually involves placing the data into a chart, table or graphic format having a recognized way of interpreting the information. In some cases, this understanding is implicit in the way the data is presented. For example, data presented in a pie-chart format suggests to the user that the data is meant to be viewed as part of a percentage metric. Similarly, data presented in a bar graph is meant to convey that the data must be understood against the measurements of at least two axes. In other cases, the way the data is meant to be understood must be explicitly explained to the viewer. This can be done by providing tools like keys or color coding. As an example, text or information displayed in the color green may very often symbolize a nominal or beneficial number, whereas similar in the color red may connote negative trends or characteristics. Even though this usage of colors is intuitive to many users, this intuition may be culturally dependent. Therefore, the information may need to be further explained for the benefit of people who might not understand it.

Lacking in conventional data visualization techniques is the way information can be manipulated once it is already prepared or processed for visualization. For example, a graph or a pie chart is often the end result of a calculation, which is then transferred into a graphic with the above-mentioned principles being used. In order to change what a bar graph is showing, many times the information must be “processed” again, transformed and redisplayed. Oftentimes, this recalculating is done via the navigation of a menu or the selection of some outside metric. There are also several problems with the traditional way of interacting with data on the limited screen space available to most touch screen devices.

First, since the user is operating with a relatively small amount of space, navigating away from a chart or graph can be tedious or confusing, requiring repeated navigations of menus and the selection of actions. For example, on a bar graph displaying sales of oranges over a period of time, there are two axes: amount and time. If the user wishes to add another variable to the graphic, say lemons for example, they must navigate a menu, select “lemons” and then allow the software to recalculate the graph. This process of navigating away from the graphic represents a significant amount of lost time, but it also creates a visual disconnect that can hamper good decision making.

A second problem is that this type of navigation can be interruptive to the decision making progress. If, for example, a team of analysts are using the data interface in order to present relevant information at a conference, they have one of two options: render all graphs and graphics beforehand, with hope that they have correctly anticipated what questions will be asked, or generate the visualizations on demand. The latter is obviously the preferable choice, but it demands an interface that can support it.

Accordingly, another aspect of the systems and methods disclosed herein is in the form of a computer program stored in a memory, including executable instructions operating on a computing device, to communicate information across recipients. The method of communicating information is particularly suited to computer software requiring passing data or parameters from one window to another as suggested above (disc-to-frame, frame-to-frame, etc.); a window is a very common embodiment of a recipient defined as a screen area where some content is displayed or an application is running in to. This embodiment relies on a common semantic specifying the content of the two recipients.

The drag and drop or frame-to-frame aspect is related to the transmission or sharing of information from one source recipient to a target recipient. The information must be formalized according to a uniform semantic interpretable by both recipients (source and target). Accordingly, the system focuses on the programmable instructions aiming at identifying the piece of information from the source recipient and communicates it to the target recipient. The information dropped into the target recipient is interpreted and processed accordingly. This whole process is referred to as a recipient-to-recipient interaction.

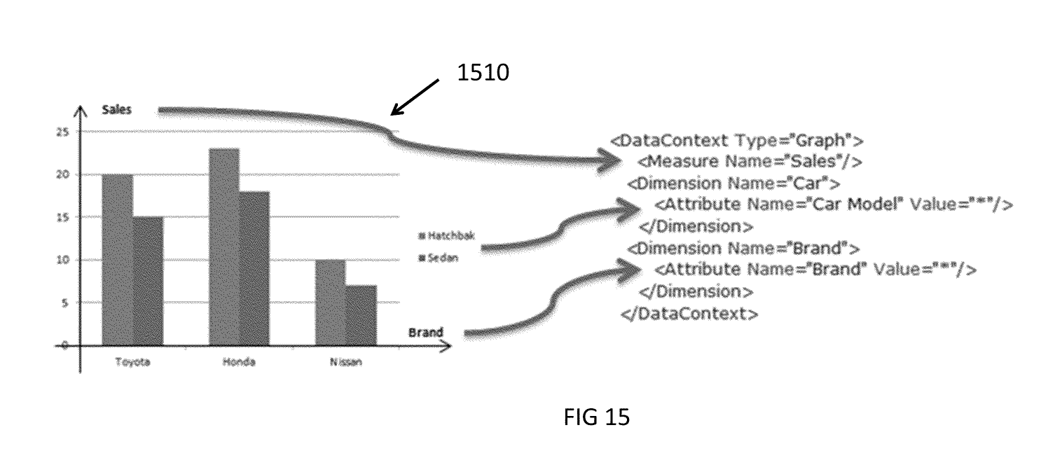

Referring briefly to the example depicted in FIG. 15, all of the content of the bar graph 1510 is movable. The axes labeled “Brand” and “Sales” represent metadata, so called “data about data.” The information displayed on each axes are the actual elements. In this case, the two elements “Toyata” and “Honda” are selectable objects with their own associated values that can be manipulated. Each of these selectable objects, whether metadata (“Brand”) or elements (“Toyota”), is labeled with a tag such as “Measure,” “Dimension,” “Attribute,” or “Value.” This labeling scheme indicates the object's place in the semantic data landscape that is configured beforehand. The labeling scheme also determines what the data is, and how the data will be organized when it is dragged and dropped onto the recipient. This tagging process is integral to the ability to access and apply the information. The “Data Context” is in this case a two dimensional graph, with the characteristics of the graph already decided before hand—a bar graph with X and Y axes. The “Measure” chosen for this particular graph is sales, by amount, and so it is appropriately labeled along the X axis. The “dimension” being examined (e.g., Cars) is plotted along the Y axis, with the dimension further broken down into “Attribute Name” categories to represent the different models of those cars—in this case, hatchbacks and sedans. Another dimension plotted along the Y axis is the brand of car.

The content of every recipient is a set of selectable objects. For instance, the two axes “Brand” and “Sales” in the graph depicted in the left side of FIG. 15 are two separate objects of type “axis”; the legend, as well as every bar, is another type of object. These objects are all related to metadata that is specified in the data context of the recipient. Furthermore, the value on the axis “Brand” such as “Toyota”, “Honda” and “Nissan” are selectable objects as well; those are elements, or values, as opposed to metadata. That is important to differentiate metadata from value because both are treated differently when interacting.

Each object is labeled with a tag such as “Measure”, “Dimension”, “Attribute” or “Value” as depicted in the right side of FIG. 15. This indicates what the object is from a semantic standpoint. The thesaurus of tags defines a semantic characterizing the recipient content in the associated data context. The following is an illustrative example. Suppose the user wanted to add a fourth brand to the graph, perhaps “Subaru.” They would select the brand from another source (e.g., another graph, a list, the miVEDiX DISC, etc.) and, using the touch screen's drag-and-drop feature, drag it and drop it on the graph. Since the data context of this visual is determined to be a “Graph,” and since “Subaru” would already be tagged as an attribute value, the graph will automatically place “Subaru” on the Y axis, visualized as a cluster of two bars. In addition, and if the data so exists, “Subaru” will also display the “Car Model” attribute, listed under the dimension of “Car.” So, like the other car brands listed, the “Subaru” entry will show both hatchbacks and sedans.

Because the semantic is uniform across all of the various recipients and objects, the system allows the real time derivation of information, statistics or outcomes simply by the insertion or removal of relevant objects and the data they represent. And, because the semantic is uniform across the data context all recipients share the same kind of objects, opening the door to valid interaction between recipients. In this way, the interaction is made possible between a source and a recipient. The uniqueness of the systems allows the source and recipient to be different. It is possible to drag a variable from a pie-chart and drop it into a plotted line graph, or drag a variable from a standard column chart and include it in a bar graph. Provided they are operating under the same data context semantic, all of the information will be interchangeable to create an almost unlimited number of combinations, displays and outcomes. Dropping an object to a target recipient is equivalent to an update or extend the data context with a known object type. Thus, an interaction is made possible between a source and a target recipient. Those two recipients can be of a different nature; nonetheless, interaction is possible as long as they share the same data context semantic. For instance, in the miVedix system (described below) there are two kinds of recipients: “Disc” and “Frame”; two kinds of interaction are therefore allowed: frame-to-frame and disc-to-frame interactions.

Data Context: Neutral Query Specification

The data context methodology is employed to map the complex and heterogeneous physical world of data to a uniform semantic. The syntactic cues are arbitrary and may be driven by existing standard formats such as XML or Jason. The disclosed embodiment focuses rather on the semantic necessary for visualizing, analyzing and interacting with data.

The specification of the data access is a sequence of several sentences following the syntactic cues of the format. This constitutes a neutral and comprehensive (non-ambiguous) data context giving the directives to software for accessing data from external sources regardless of their nature and technology.

A data context necessitates mapping the uniform semantic to some specific source objects. The mapping is described as a logical step necessary for the disclosed system to be workable, but it is not necessarily part of the system itself. Therefore, the components necessary for the implementation of the mechanism for handling the mapping may or may not be incorporated with the system.

The disclosed method applies in the world of analytics, which encompasses data analysis and reporting activities. The semantic of analytics has been largely influenced by the concept of multidimensionality and the online analytical processing (OLAP) technology, grassroots of data warehouses. The pivotal concept in analytics is: dimension. A dimension provides the means to “slice and dice” data in a data warehouse. Dimensions provide structured labeling information to otherwise unordered numeric measures. For example, “Customer”, “Date”, and “Product” are all dimensions that could be applied meaningfully to a sales receipt. A dimensional data element is similar to a categorical variable in statistics.

Complementary to dimension is the concept of fact. A fact table consists of the measurements, metrics or facts of a process. It is often represented in a data model at the center of a star schema or a snowflake schema, surrounded by dimension tables. Fact tables provide the (usually) additive values that act as independent variables by which dimensional attributes are analyzed.

A measure is a specific measurement from a fact table. A measure is a property on which calculations (e.g., sum, count, average, minimum, maximum) can be made. For example if a retail store sold a specific product, the quantity and price of each item sold could be added or averaged to find the total number of items sold and total or average price of the items.

Dimensions and facts exist in the physical world stored as pieces of data in various and heterogeneous databases or external systems. Getting the data off of those systems represents a first difficulty because the underlying technology is different. Two predominant standard query languages exist: structured query language (SQL) and multidimensional expressions (MDX); this is part of the problem since one language does not cover the two types of data warehouse: SQL is used for relational and MDX for dimensional databases. Moreover, SQL and MDX are suited essentially for accessing structured data stored in databases but not data, often unstructured, residing on the Internet for instance. Application programming interfaces (API's) are generally used for accessing data off Internet that is out of grasp of the current query languages. The second problem is that many source systems, including data warehouses, do not have a semantic layer capable to categorize the pieces of data like dimension attributes versus facts or measures. This task is basically left to the software.

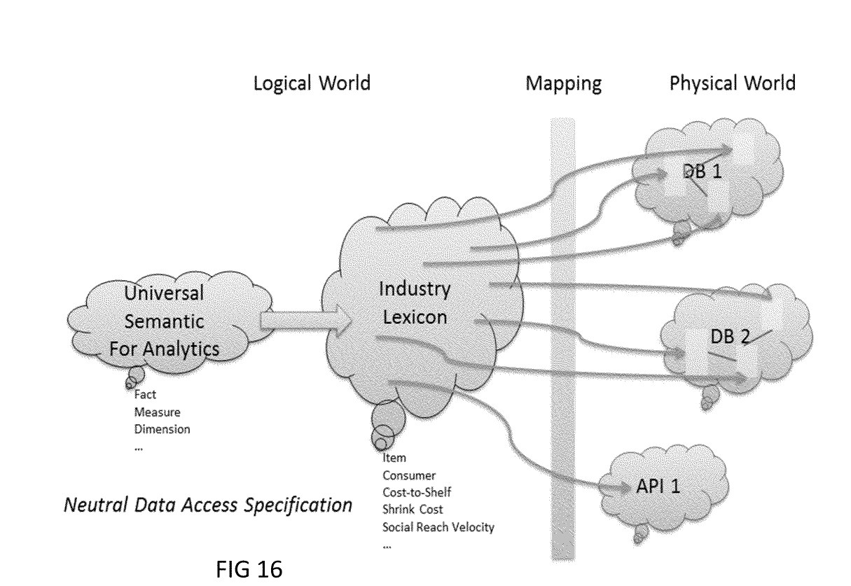

Referring to FIG. 16 the schema depicted shows the physical world on the right side made of databases and external systems, as a specific web site, requiring specific API's to get data out. On the left side of the figure there is the logical world formalized with a common semantic for analytics. There is also a need for a lexicon, specific for each industry such as Telecommunications, Health Care, Retail, Service, etc., whose entries are associated with a word part of the semantic. For instance, “item” and “consumer” could be defined as dimensions, “shrink cost” and “cost-to-shelf” as measures.

An example of Neutral Data Access Specification is illustrated in the following text.

<DataContext Type=“Grid”>

```
  <Measure Name=“Sales Amount”/>
  <Measure Name=“Sales Quantity”/>
<Dimension Name=“Store”>
```

<Hierarchy Name=“Store”>

<Level Name=“Level01” Value=“*”/>

</Hierarchy>

</Dimension>
<Dimension Name=“Time”>

<Hierarchy Name=“Sales Time”>

<Level Name=“Level01” Value=“*”/>

<Hierarchy>

</Dimension>
</Dimension Name=“Product”>

<Hierarchy Name=“Product”>

<Level Name=“Level01” Value=“*”/>

<Hierarchy>

</Dimension>

</DataContext>

This data context is a request for getting two measurements: “Sales Amount” and “Sales Quantity” at the intersection of three dimensions: “Store”, “Product” and “Time”. This data context would allow “drilling down” the data because each dimension contains a hierarchy; the response will be a set of sale values aggregated at the top level (level01) of the hierarchy of each dimension, for instance, “State”, “Year” and “Product Category”.

The tags (e.g., DataContext, Measure, Dimension, Hierarchy, Level) are valid keywords and form part of the uniform analytics semantic. Each tag may be supplemented with attributes (e.g., Type, Name), whose values appear to the right. The data context will be semantically correct at the condition every value is a valid entry in the industry lexicon.

The mapping of the values to physical objects such as table attributes, cube dimension attributes, or API formal parameters enables a common software component, the dynamic query engine, to generate a request to the source system(s). The request may be a SQL or MDX query or a URL with adequate parameters given the type of database or source system. The important property of such a data context is that the source systems, whatever the number of them and the nature thereof, are transparent. In other words, the specification is fully neutral.

Visualization Topology: Graph Topology Determination (GTD)

The Graph Topology Determination is employed to choose an appropriate type of graph and decide of an adequate data layout given a set of values specified by a data context. Examples of graph types are: pie chart, line chart, bar graph, bubble chart, among others. Determining the data layout in a graph is essentially performed by allocating dimensions or measures to graphical components such as axes, lines, bars, bubbles, pie slices.

This task is essentially a manual human task in most data analysis tools; the user picks itself a type of graph available thru a catalog of available visualizations. Hence, one goal of the disclosed system and methodology is to develop a deterministic process (GTD) given a set of data to decide, or assist the user in selecting, the best kind of visualization among a catalog of pre-defined graph types. The data context associated to the set of data is an essential driver for GTD.

A deterministic process such as GTD cannot function unless a formal topology of data visualization exists related to a semantic specifying the objects to display. The data visualization topology is a simple equation (DVT equation) aimed at sizing and structuring the content of the structure of data to visualize: M+D=N where M is the number of measures, D is the number of dimensions and N is the total, representing the “topological size” of the set of data. M and D cannot be null (i.e., M>0 and D>0), as a graph with no measure or no dimension does not make sense. An important property, referred to as cardinality, applies to every dimension. The absolute cardinality Ca(D) of a dimension D is the number of distinct elements inside it. The cardinality relative Cm(D) to a measure is the number of distinct elements in the dimension for which a measure value exists. The cardinality of each dimension of a given topology is not visible in the DVT equation; the full view of a data set topology includes therefore a DVT equation and the cardinality of every dimension in it.

Complex visualizations require the cardinality computation to be generalized to a set of dimensions. Cm(D1, D2, . . . , Dn) is then the number of distinct combinations of the elements inside D1, D2, . . . , Dn.

Each type of graph comes with a topological constraint. The DVT is essentially relevant for graphical visualizations because non-graphical data visualizations such as tabular grids do not have topological constraints; the number of columns or rows is theoretically unlimited. In other words, N can be infinite. This is not the case for graphical visualizations however.

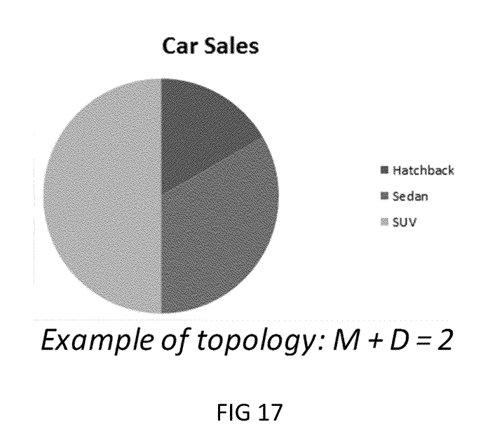

A pie chart, for instance the chart depicted in FIG. 17, can only carry on a topology of: 1M+1D=2, one measure and one dimension. The pie chart example of FIG. 17 shows a measure: “Car sales” of car models (Dimension); the size of each slice being proportional to the measure value.

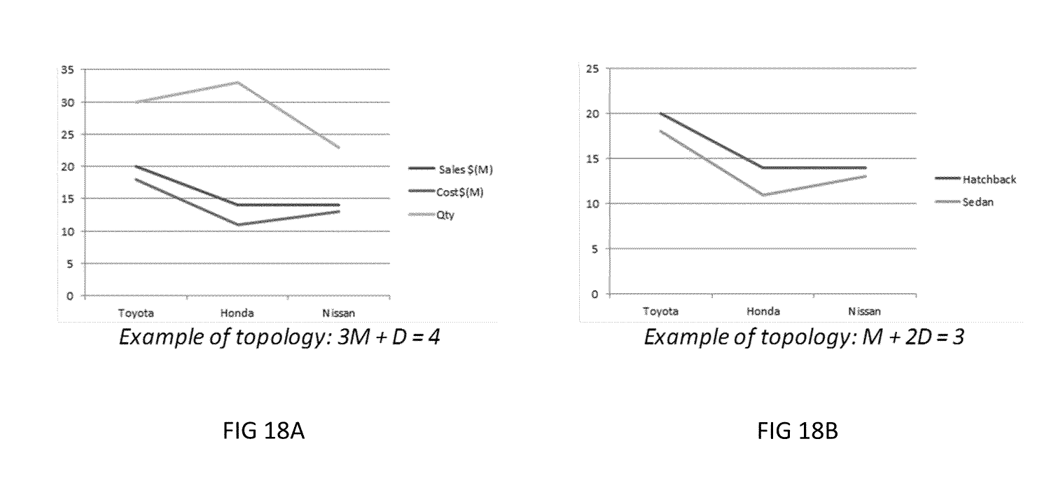

In a line chart (2D), for example FIGS. 18A-18B, the number of measures is theoretically unlimited assuming a line is allocated to each measure. In practice, this number must be limited to an arbitrary number: N−1. So that one possible topology of 2D line chart is: M+1<=N. The mandatory term 1 in the left side of the topological equation indicates that the number of dimension is strictly limited to 1. Another valid topological configuration for line chart is: 1+D<=3; two dimensions are allowed with the constraint to have one measure solely, each element of one dimension being assigned to a specific line. Additional exemplary topologies are also illustrated in FIGS. 18A-18B.

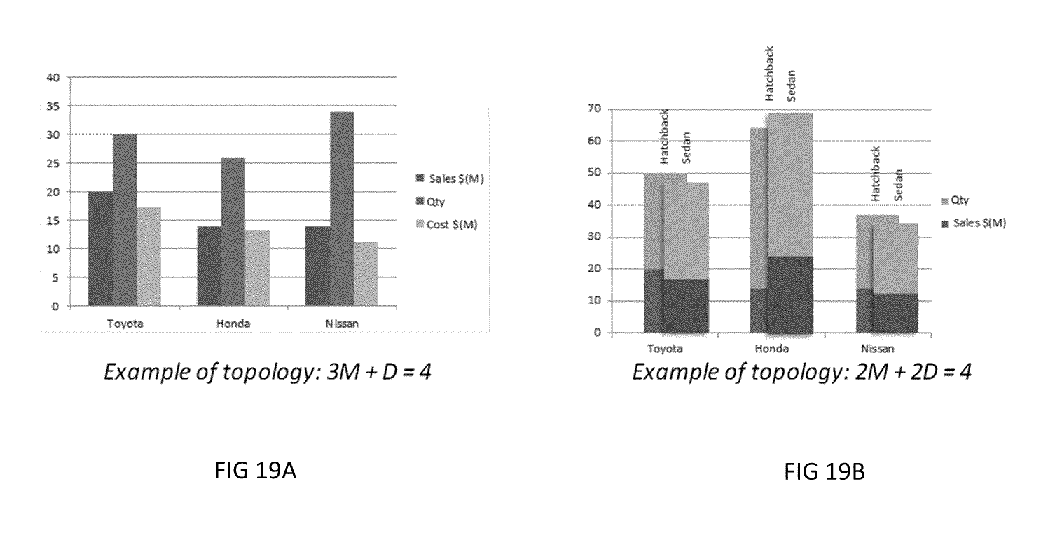

Like a line chart, assigning a large number of measures to different colored bars is possible in a bar chart so: M+1<=N assuming an arbitrary number of N−1 measures cannot be exceeded. The sum of dimensions and measure cannot be more than 4 if there is more than one measure, hence the topological constraint: M+D<=4 where M>1. The total 4 of this DVT equation shows there is more “space” (4) in a bar chart than in a line chart (3); the reason being that a bar can be split into several areas (stacked bar) each area being allocated to either a given measure value or dimension element. FIGS. 19A and 19B are illustrative examples of different topologies for bar charts or graphs.

The allocation of a measure or a dimension to a particular axis or other object such as a line or bar needs to be determined by the GTD. In one embodiment, the determination is computed based on the cardinality of the dimensions. Taking the example of a bar graph having the topology: M+2D=3; according to this DVT equation, there are two dimensions named: D1 and D2. The question becomes, which one to allocate to the X axis of the chart? To answer this question, the GTD first computes the cardinalities: C1=C(D1) and: C2=C(D2). Second, based on the condition: C1>C2, if C1>C2 then D1 will be assigned to the X axis, and otherwise D2 is assigned to the X axis. The dimension not assigned to the X axis has to be represented in the bars either as stacked bars or clustered bars. In both cases, however, the cardinality of the non-axial dimension must not exceed an arbitrary number N otherwise an exception is raised alerting the system that the topology is too complex for visualization.

What-if Tree of Measure

The what-if functionality, as represented, for example, in FIGS. 22A-22B, illustrates that the business intelligence system may also enable visualization of changes to a plurality of outcomes based upon adjustment, of at least one variable. More specifically, executable instructions first produce a display of, for example, sales as represented in the middle region of each of the displays. By adjusting the cost “thumbwheel” 2220 in the lower left of the region, it is possible to vary or adjust the cost and in doing so one is able to produce a real-time representation of the impact of changing the cost on both the resulting revenue both before and after tax, as reflected in fields 2230 and 2232, respectively.

Although the example of the what-if functionality is represented in a simplified sales/revenue model, where the adjustable variables are sales (units) 2210, costs 2212, and tax 2214, it is clear that the adjustment of either or all of the sales, costs and tax thumbwheels will alter intermediate and/or final calculations that are based upon such data. Thus, the what-if feature provides any easy way for a user to view the impact of changes to input variable. The resulting fields, where numeric values are displayed may also be color-coded so that there is a reinforcement of the values (e.g., using green for revenue above a certain threshold and red for revenue below the threshold). Or, varying or multiple thresholds and a plurality of colors may be employed in order to make the what-if system customizable.

Linkage of Social Media with Database Data

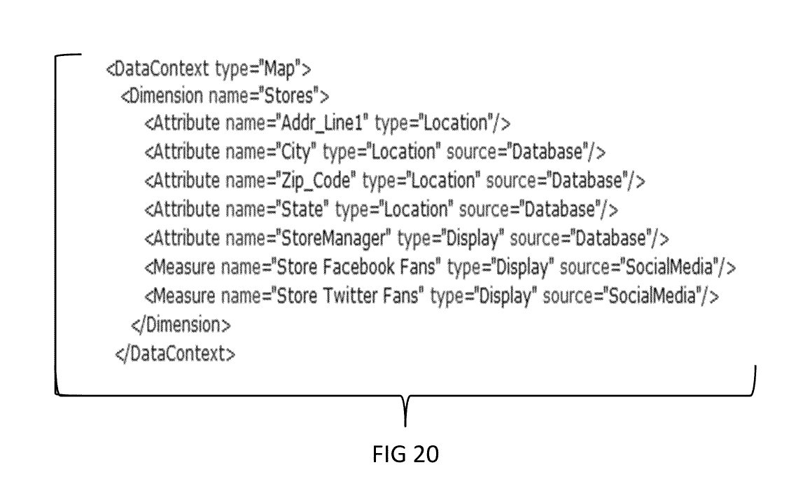

The advent of cyber personas on Twitter, Facebook, blogs, YouTube, music sites etc., with faster and more ubiquitous bandwidth, rich media along with other natural language content is both pervasive and invasive to an organization's ecosystem. The methodology disclosed herein is used to a map, in a data context, some pieces of data coming from internet API's. Other pieces of data are stored in databases. An example of data context mixing internet data with databases is shown in FIG. 20, wherein the schema disclosed above is once again applicable.

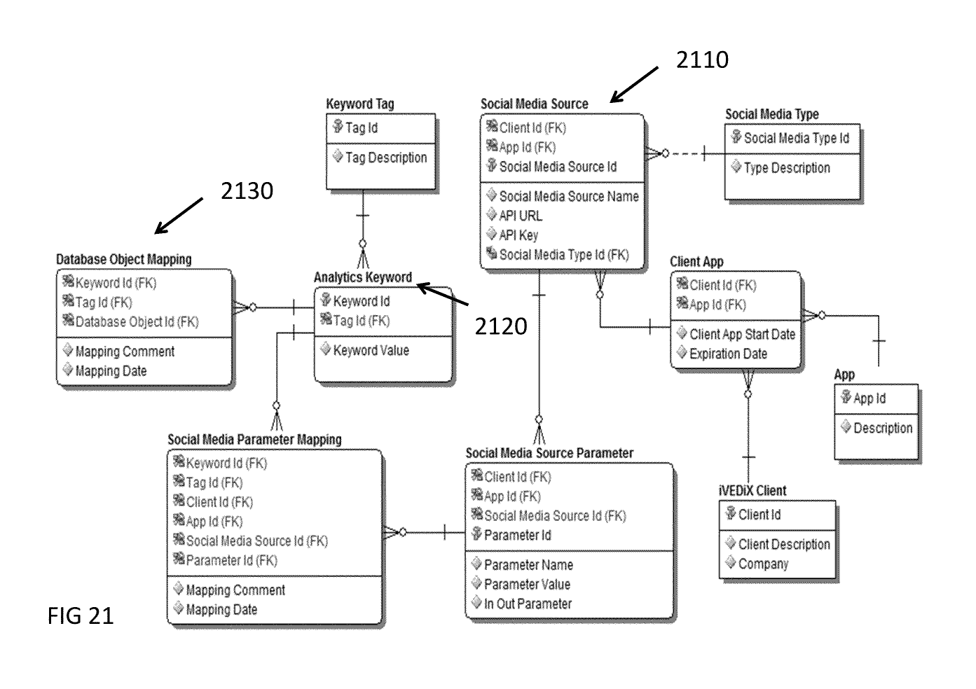

Referring to FIG. 21, the Social Media Source (SMS) occurrence 2110 is attached to some parameters table: “Social Media Source Parameter” mapped to the uniform semantic thanks to the table: “Analytics Keyword” 2120, which provides the database objects thru the “Database Object Mapping” (DOM) 2130. For instance, Store Name and State could be two parameters mapped to database objects whose values can be passed as parameters when consulting the social media API to get the number of fans.

miVedix

Within the miVEDIX architecture, the visual elements directly source data from backend databases, social media interfaces and other structured or unstructured sources via a unified data model (UDM). As will be appreciated from the disclosure herein, the unified data model could be supported by any combination analytics data store(s) (ADS), several unified dimensional databases (UDD, OIAP Cubes, External APis and/or External web services. Along with the unified data model, the analytics data store layer is an Important component of the framework as it facilitates a single yet dynamic upstream data source for the visual elements. Furthermore, an analytics data store component ensures data integrity across structured and unstructured content.

Communication between the visual elements of the app layer and the database is fundamentally managed via Web service, in one embodiment. These web services are platform agnostic components controlling the bidirectional data flow (calls and responses) between the app and the data sources. These web services use native database drivers to ensure performance with respect to data retrieval and response times. Native drivers also ensure the propagation of native security from the data sources. In addition to native database level security inheritance, the web services Interface with the miVEDiX Core Security and Registration Master Database (Security Module-mIVEDiX SMD). This module can also be integrated with corporate lightweight directory access protocol (LDAP) Instances.

The web services handle a neutral message format: XML data embedded under the simple object access protocol. The architecture can reside within a hosted (cloud based) or controlled (enterprise managed) environment.

Also contemplated in association with one or more of the features disclosed herein is the use of a tag cloud or similar mechanism (see e.g., http://iosguy.com/2010/11/17/creating-a-3d-tag-cloud/) for the display of various pieces of information such as keywords, variables, etc. as a means for allowing a user to make a selection from a large set of possibilities.

It should be understood that various changes and modifications to the embodiments described herein will be apparent to those skilled in the art. Such changes and modifications can be made without departing from the spirit and scope of the present disclosure and without diminishing its intended advantages. It is therefore anticipated that all such changes and modifications be covered by the instant application.

What is claimed is:

1. A business intelligence system including a navigational device, said device comprising:
a contextual radial menu apparatus; and
a partial shield on top of at least a portion of said contextual radial menu apparatus,
wherein both the contextual radial menu apparatus and the shield are operatively associated with a common axis.

2. The business intelligence system of claim 1, further including a computer readable storage medium with executable instructions to perform within an application context.

3. The business intelligence system of claim 1, further including a computer readable storage medium including executable instructions to configure the content and the layout of a mobile app, wherein said app includes a business intelligence dashboard displaying, and interacting with, data in one of a plurality of visualizations.

4. The business intelligence system of claim 3, further including executable instructions to communicate information across various recipients, wherein information depicted in a first visualization is passed to another visualization.

5. The business intelligence system of claim 1, further including instructions that are executed to parse syntax and convert it into a specific query language for accessing data directly from a source accessible via a resource locator.

6. The business intelligence system of claim 1, further including a method, executed in response to programmatic instructions, to bundle data available from the Internet with traditional data to from at least one database.

7. The business intelligence system of claim 1, further including a configurator enabling deployment of a plurality of customized business intelligence apps on mobile devices, wherein said apps comprise visualization elements.

8. The business intelligence system of claim 1, further including executable instructions, to enable visualization of changes to a plurality of outcomes based upon user adjustment, of at least one variable.

9. The business intelligence system of claim 1, wherein said contextual radial menu apparatus is depicted on a display device as a disc-shaped rotating wheel.

10. The business intelligence system of claim 9, wherein the rotating wheel includes a plurality of retractable inner rings, where each of said rings represents a selectable menu and further includes sub-menu items.

11. The business intelligence system of claim 10, wherein the shield further includes at least one action button.

12. A business intelligence system, comprising:
at least one computer operatively associated with a network;
a data source, including a memory accessible by said computer;
a data access module, wherein the data source stores and supplies data for the data access module;
a contextual menu module;
a graphical user interface module, operatively associated with a user interface to enable the display of graphical elements and to receive, as input, gestures via a touch-sensitive input device; and
a configurator database, said configurator database includes objects that enable a generic application to run a specific occurrence, wherein the objects include at least one app and at least one app resource associated with the at least one app and where the configurator database stores the configuration of a plurality of app instances.

13. The business intelligence system according to claim 12, further including the at least one computer operating, in response to programmatic instructions retained in a memory, to communicate information from a source recipient to a target recipient in a recipient-to-recipient interaction, where a dynamic query engine, operates in response to a Neutral Data Access Specification to access the source recipient and provide the information to the target recipient.

14. The business intelligence system according to claim 12, further including executable instructions, to be carried out by the computer, enable visualization of changes to a plurality of outcomes based upon user adjustment, of at least one variable.

15. A business intelligence method comprising:
initiating at least one app, operating on at least one computer, wherein said app is initiated with a set of configuration parameters stored in a configurator database, said app including at least one app resource being displayable and thereby permitting a user to interactively view a display responsive to the app;
loading the configuration for the at least one app to a device, includes reading an app ID in the device, verifying device authorization; sending a request to a configurator and in response, uploading the app resources to the device prior to displaying a home screen for the app;
providing a data source, including a memory accessible by the computer, and a data access module, wherein the data source stores and supplies data for the data access module;
providing a graphical user interface module, operatively associated with a user interface to enable the display of graphical elements produced by the app and to receive, as input, gestures via a touch-sensitive input device, to thereby provide an interactive display of information for the at least one app.

16. The business intelligence method according to claim 15, further including communicating information from a source recipient to a target recipient in a recipient-to-recipient interaction, where a dynamic query engine, operates in response to a Neutral Data Access Specification to access the source recipient and provide the information to the target recipient.

17. The business intelligence method according to claim 16, further including enabling visualization of changes to a plurality of outcomes based upon user adjustment, of at least one variable.

18. The business intelligence method according to claim 15, further including a display depicting a contextual radial menu apparatus.

19. The business intelligence method according to claim 18, wherein the contextual radial menu apparatus displays a representation of at least a plurality of apps and data sources.
